(19) United States
(12) Patent Application Publication
(10) Pub. No.: US 2003/0065816 A1
(43) Pub. Date: Apr. 3, 2003

(54) User-preferred network interface switching using route table manipulation

(75) Inventors: Abhay A. Dharmadhikari, Beaverton, OR (US); Ryan H. Nguyen, Aloha, OR (US); Michael B. Andrews, Beaverton, OR (US); Nikhil M. Deshpande, Beaverton, OR (US)

Correspondence Address: Schwegman, Lundberg, Woessner & Kluth, P.A., P.O. Box 2938, Minneapolis, MN, 55402, US

(73) Assignee: Intel Corporation

(21) Appl. No.: 09/967,065

(22) Filed: Sep. 28, 2001

(51) Int. Cl. G06F 15/173

(52) U.S. Cl. 709/240; 709/239

(57) ABSTRACT

A computerized system includes a user interface component operable to specify user preferences; and a policy manager component capable of receiving the user preferences, selecting a network interface from a plurality of network interfaces by matching the user preferences to a set of characteristics for a network interface, and modifying a routing table entry according to the selected network interface.

### FIELD

The present invention relates generally to computerized systems and methods for switching between network interfaces for routing network data, and more particularly to manipulating routing table entries to express a user-preferred network interface for routing network data.

### COPYRIGHT NOTICE/PERMISSION

A portion of the disclosure of this patent document contains material that is subject to copyright protection. The copyright owner has no objection to the facsimile reproduction by anyone of the patent document or the patent disclosure as it appears in the Patent and Trademark Office patent file or records, but otherwise reserves all copyright rights whatsoever. The following notice applies to the software and data as described below and in the drawings hereto: Copyright© 2001, Intel Corporation. All Rights Reserved.

### BACKGROUND

An ever-present trend in computer systems is that each new generation is typically faster, smaller and has more features than the previous generation. For example, computers once occupied entire rooms. Since that time, computers have evolved to desktops, laptops, and today, computer systems exist that can be held in the palm of one's hand. As a result of these improvements, computers have become mobile. Many computer users have laptop computers that can be carried and used in various locations in the office, in the home, and in the classroom.

Similarly, network systems have also evolved over time. Previous generations of network systems were comparatively slow and required bulky cabling. Present day network systems are faster and more versatile than previous generations. For example, network interfaces in today's systems can be either wired or wireless. Furthermore, within each category there are further network types. For example, wired networks can operate over coaxial cable, various forms of twisted pair cables and fiber optic lines. Likewise, several standards exist for wireless networks, including the proposed Bluetooth standard (v.1.1) by the Bluetooth SIG, Inc., and the IEEE 802.11 Wireless LAN (Local Area Network) standard (IEEE 802.11, 1999 Edition; ISO/IEC 8802-11: 1999).

Wired and wireless network interfaces generally have different characteristics. Wired networks typically support higher bandwidth and transmission rates than wireless network interfaces, and typically cost less to operate than a wireless network interface. However, as the label implies, a wired network interface must be physically attached to a network access point by a cable, thus limiting the location possibilities of a computer using a wired network interface. Wireless interfaces, while typically more costly to operate, can be located anywhere within the radio frequency range of wireless network transceiver. Thus a computer with only a wireless network interface is more portable from a network viewpoint than a computer with only a wired network interface.

In order to provide the best of both the wired and wireless worlds, computer users often will have both a wireless and a wired network interface in a portable computer. When the user is near a wired network access point, the user will typically use the wired network interface to obtain the high speed/low cost benefits of wired networking. When the user is not near a wired network access point, the user will typically use the wireless network interface in order to obtain a network connection that would otherwise be unavailable.

For example, consider a user of a portable computer (e.g. a laptop) with both a wired and wireless network interface in an office complex. Typically the user will have a wired network access point located near the user's desk. Here, the user will want the laptop system to communicate via the wired network interface. Now assume the user wishes to use the laptop while attending a meeting in a conference room, and further assume the conference room does not have any wired network access points available (e.g. they are all in use, or none exist in the conference room). Here, the user will want the laptop system to communicate with the network using the wireless network interface. When the user returns to their desk, the user will typically want to switch back to using the wired interface.

In previous systems, a user that desires to switch between a wired and wireless network interface or between wired interfaces on different subnets must typically manually manipulate the network configuration in order to enable the desired interface and disable the other interface. This manual operation can be complex, and frequently requires the user to reboot their system. As a result, switching between interfaces can be both complicated and time consuming.

In addition, the manual switching process described above is typically used when a user desires to move the computer from a network access point on one subnet to a network access point on a different subnet.

In view of the above problems, there is a need in the art for a mechanism that provides for the automatic determination of a preferred network interface.

### BRIEF DESCRIPTION OF THE DRAWINGS

FIG. 1 is a block diagram illustrating a system level overview of an exemplary embodiment of the invention;

FIG. 2A is a diagram illustrating elements of an exemplary routing table used in various embodiments of the invention;

FIG. 2B is a diagram illustrating elements of the exemplary routing table after manipulation according to an embodiment of the invention;

FIG. 3 is a flowchart illustrating a method for manipulating a routing table according to an embodiment of the invention; and

FIG. 4 is a flowchart illustrating a method according to an embodiment of the invention for manipulating a routing table when a network link status changes.

### DETAILED DESCRIPTION

In the following detailed description of exemplary embodiments of the invention, reference is made to the accompanying drawings which form a part hereof, and in which is shown by way of illustration specific exemplary embodiments in which the invention may be practiced. These embodiments are described in sufficient detail to enable those skilled in the art to practice the invention, and it is to be understood that other embodiments may be utilized and that logical, mechanical, electrical and other changes may be made without departing from the scope of the present invention. The following detailed description is, therefore, not to be taken in a limiting sense.

In the Figures, the same reference number is used throughout to refer to an identical component which appears in multiple Figures. Signals and connections may be referred to by the same reference number or label, and the actual meaning will be clear from its use in the context of the description.

The detailed description is divided into multiple sections. In the first section the software operating environment of different embodiments of the invention is described. In the second section methods according to various embodiments of the invention are described. In the final section, a conclusion is provided.

### Operating Environment

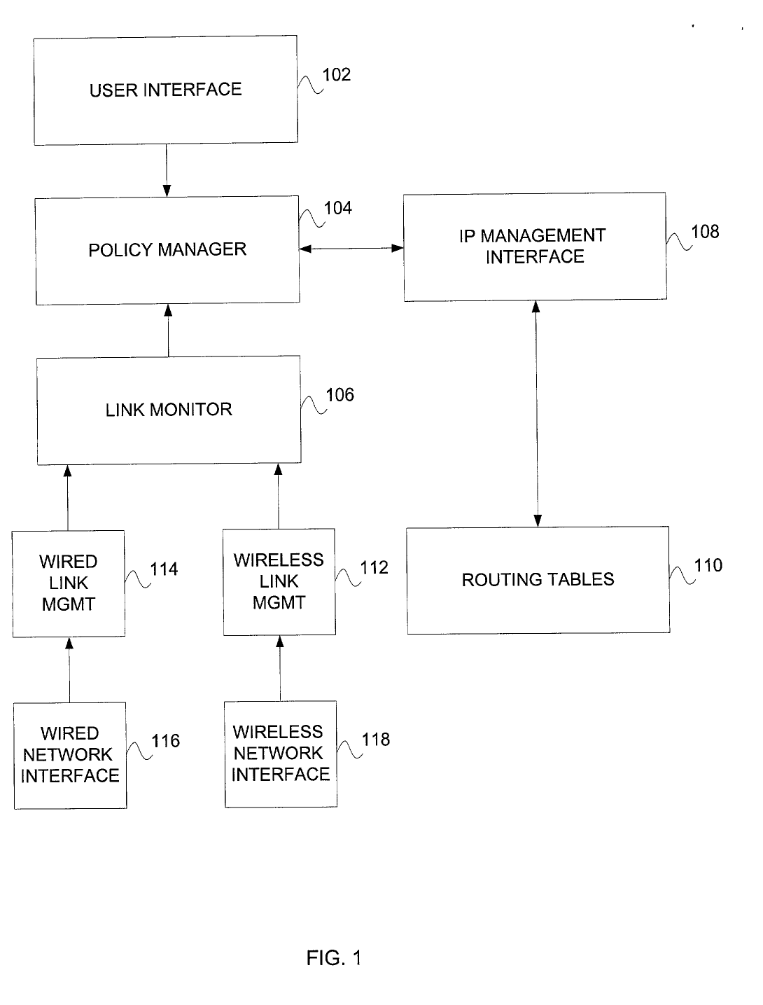

FIG. 1 is a block diagram of hardware and software components included in various embodiments of the invention. The systems and methods of the present invention may be executed on any hardware that supports a plurality of network interfaces. Typically such hardware includes personal computers, server computers, mainframe computers, laptop computers, portable handheld computer and personal digital assistants (PDAs). In some embodiments of the invention, two network interfaces are supported, wired network interface 116 and wireless network interface 118. Wired network interface 116 is a network interface designed to support wired connections to a network access point. Examples of wired connections include fiber optic, twisted pair, and coaxial cable connections between the network access point and the network interface. In one embodiment, wired network interface 116 is a network interface in the Intel® PRO/100 family of mobile adapters available from Intel Corporation.

Wireless network interface 118 is a network interface designed to support wireless connections to a network access point. Examples of wireless connections include infrared networks and radio frequency (RF) networks, including those that support the Bluetooth de facto standard. In one embodiment, wireless network interface 118 is a network interface in the Intel PRO/Wireless family of adapters available from Intel Corporation. However, the invention is not limited to any particular wired or wireless network interface. Furthermore, the invention is not limited to any particular number, type, or combination of network interface adapters. For example, the present invention may be adapted to more than two network interface cards. Additionally, the network interface cards may be all wireless network interfaces, all wired network interfaces, or any combination of the two.

The software components are typically read from a computer-readable media and run under the control of an operating system, and interface with the operating system. Examples of such operating systems include Windows® 95, Windows 98®, Windows Me®, Windows CE®, Windows® NT, and Windows 2000® by Microsoft Corporation. However, the present invention is not limited to any particular operating system, and in alternative embodiments the software components may operate within the Palm OS® from Palm Inc. or variants of the UNIX and Linux operating systems.

In one embodiment of the invention, the software components include user interface 102, policy manager 104, link monitor 106, and IP management interface 108. User interface 102 provides an input/output mechanism for a user to provide input regarding the user's preferences related to the selection of a desired network interface from a plurality of network interface cards 116 and/or 118 communicably coupled to the user's computer. The user interface may comprise a number of user interface elements such as dialog boxes, radio boxes, sliders and other interface elements known in the art. These user interface elements are then used to communicate the user's preferences. Examples of such preferences include interface type preferences, cost preferences, latency preferences, reliability preferences and bandwidth preferences. Thus the user may express a preference to use a network interface attached to a low cost network over a high cost network. Similarly, the user may express a preference to use a high bandwidth network over a lower bandwidth network regardless of the cost. Alternatively, the user may express a preference to always use a wired interface when one is available. Furthermore, the user may express a preference to use an interface that consumes less battery power than other interfaces. The example preferences illustrated herein are not meant to be exhaustive, and other network use preferences are possible and within the scope of the invention.

A set of one or more preferences is referred to as a policy. The user may define different policies comprising different sets of preferences, and select a policy that should be enabled.

Link monitor 106 receives link status information for network interfaces coupled to the computer. In simplified terms, the link status indicates whether or not the network interface is connected to the network and whether or not the link can transmit and/or receive data over the network. The link monitor thus senses changes in the link status. Changes in link status may be due to a variety of reasons, examples include inserting a network interface card, removing a network interface card, a new link being made available, and so on. In some embodiments, link monitor 106 uses components that monitor particular types of network interfaces. In these embodiments, wired link management component 114 monitors wired network interfaces, and wireless link management component 112 monitors wireless network interfaces. In some embodiments, wired link management component 114 is the NMS (Network Management Services) software component available from Intel Corporation. Additionally, in some embodiments, wireless link management component 112 is the SMS (Symbol Management Services) software component provided with wireless network interfaces available from Intel Corporation. The use of separate wired and wireless link management components is not required, however it is desirable because it allows the link monitoring and management functions to be tailored for efficient management of a particular type of network interface.

Policy manager 104 receives input from both the user interface 102 and from link monitor 106. Policy manager 104 receives the user's preferences from user interface 102 and maintains the preferences for later use. The preferences may be maintained in a database as is known in the art. Alternatively, the preferences may be maintained as registry entries in a registry maintained by the operating system. Additionally, preferences may be maintained in configuration files or environment variables.

Additionally, policy manager 104 receives changes in link status for a network interface from link monitor 106. Examples of link status changes include insertion and deletion of network interface hardware, connection of network interfaces to network access points, and changes in connectivity downstream from the network access point. In addition, changes in link status can occur when a portable computer having a wireless network interface moves into the range of a network access point on a different subnet from a previously connected network access point.

Whenever link status initializes or changes, policy manager 104 correlates the currently enabled policies to match user preferences with the characteristics of the available network interfaces coupled to the user's computers. As an example, policy manager 104 may be configured with information such as the type of an interface, the available bandwidth of the interface, the latency of the interface, the reliability of the interface and the cost of using the interface. If the user has expressed a preference for using the interface connected to the network with the highest bandwidth, the policy manager will cause the operating system to select the network interface having that characteristic. In some embodiments, the policy manager adjusts values in a routing table maintained by the operating system in order to cause the operating system to select the network interface matching the users preferences.

As noted above, link monitor 106 informs policy manager 104 of changes in link status. In the case of wireless networks, wireless link status changes may be problematic when the network interface is near the boundary of an access point's coverage zone. If the network interface simply reports a binary “link up” or “link down” network interface status to the link monitor 106, and the link monitor passes this notification unmodified up to the policy manager 104, the policy manager may thrash in dealing with a flurry of “link up/down” notifications that will be generated when the wireless network interface is near the coverage boundary. In order to solve this problem, some embodiments of the invention include an “upper” and “lower” signal strength threshold. The link monitor 106 uses these thresholds to determine how to report link status changes to the policy manager. In addition, in some embodiments the link monitor 106 monitors signal strength as reported by the network interface. In these embodiments, if the link is currently in a “link down” state (as previously reported by the link monitor) and the signal strength increases enough to cross the upper threshold, a “link up” event is reported. If the link is currently in a “link up” state and the signal strength drops below the lower threshold, a “link down” event is reported. If the signal strength varies between the lower and upper thresholds (without actually crossing either threshold), no link status change will be reported. In some embodiments, hysteresis may be used to filter out rapid link up/down transitions that would otherwise occur when the signal is weak.

In further alternative embodiments, the link monitor 106 notifies the policy manager 104 of a link roam. A link roam happens when the mobile device containing a network interface enters a new access point's territory. A link roam status is a link up but coupling with a new access point. The link roam status signals to the policy manager 104 that different subnet may be accessible.

In some embodiments of the invention, a routing table entry must be either added to or removed from the routing table upon a change in link status. By way of example, Microsoft Windows 98 does not automatically add entries when a link status change occurs. Therefore, in these types of environments, the policy manager obtains an IP address and adds an entry to the routing table when a link status change indicates a new link is available. Similarly, when a link status change indicates a previous link is no longer available, the policy manager removes the associated entry or entries from the routing table and releases the associated IP address.

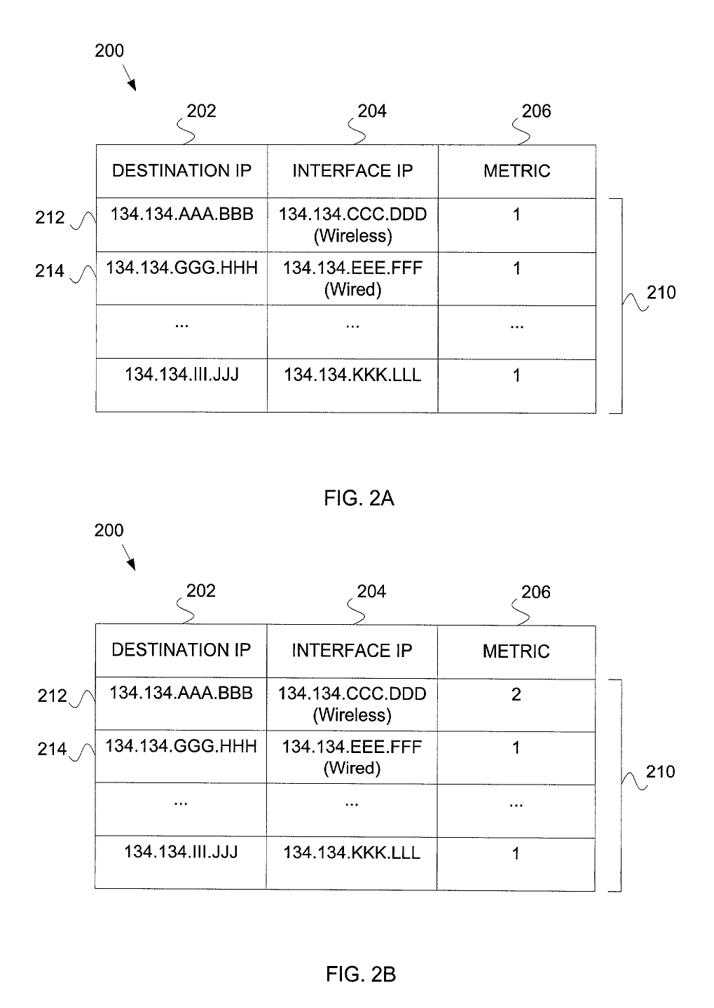

FIG. 2A illustrates an exemplary routing table 200 used in various embodiments of the invention. Routing table 200 comprises a table of entries 210 that define how the operating system will select an interface to route data to. Each entry in the table defines a particular interface. In the exemplary table 200, entry 212 represents an entry for a wireless interface, and entry 214 represent an entry for a wired interface.

Various operating systems support differing combinations of data elements in their respective routing tables. Generally speaking, routing tables include a destination IP address 202, an interface IP address 204, and a metric value 206. Routing tables also typically include a subnet mask and a gateway IP address (not shown). Destination IP address 202 is the IP (Internet Protocol) address of a particular destination. Interface IP address 204 is the IP address of the network interface that should be used to send a packet to the destination address IP address 202. Generally, a network interface's IP address is assigned by the operating system. Metric 206 is an indication of the “cost” of using the interface. Typically the metric, as assigned by the operating system, is a count of the number of hops (intervening network nodes) that a packet must take to reach the desired destination using the interface specified by the interface IP address 204.

The subnet mask defines what portion of the destination IP address must match for that route to be used. For example, a subnet mask of 255.255.255.255 (i.e. all “ones” in binary) means that the destination IP address must match exactly. As an alternative example, a subnet mask of 255.255.248.0 means the first two octets must match exactly, the first 5 bits of the third octet must match (248_{octal}=11111000_{binary}) and the last octet does not matter.

The gateway address is the IP address for the node where the packet needs to be sent in order to be forwarded on to the ultimate destination. Typically this address will either be the network interface's IP address or the address of a router on a local subnet.

In general terms, operating systems use the routing table as follows. When a packet is initiated, the operating system scans the routing table comparing the destination IP address with the interface IP address and subnet mask. For each entry in the routing table, a bit-wise logical “AND” between the destination IP address and the subnet mask is performed. The result is compared with the interface IP address 204 of the entry for a match. From the above comparisons, a list of matching routes is compiled. The route with the longest bit-wise match is chosen. In other words, the longest matching route has the highest number of bits in common with the destination IP Address. If multiple entries have identical longest matches, the routing algorithm typically chooses the lowest Metric value as the best route. If multiple entries still exist, the routing algorithm is free to select any of entries.

The route determination process results in the selection of a single entry in the routing table. The route chosen yields a forwarding IP Address (the next hop IP address) and an interface (the port). If the route determination process fails to find a route, the operating system declares a routing error. For the sending host, an IP routing error is typically internally indicated to the upper-layer protocol such as TCP or UDP. For a router, an Internet Control Message Protocol (ICMP) “Destination Unreachable-Network Unreachable” message is sent to the source host.

As discussed above, the metric value merely indicates the number of intervening nodes to the nearest gateway. In this respect, the metric is relatively simplistic, it does not take into account network bandwidth or network cost considerations. Using table 200 as an example, assume that the operating system has determined that wireless entry 212 and wired entry 214 provide an equivalent bit-wise match for the desired destination IP address. Furthermore, the metric value is the same, that is, the nearest gateway is reachable in one hop. In this situation, the operating system is free to select either interface, even though the wireless interface is likely to be slower and more costly to use than the available wired interface.

Returning to FIG. 1, in order to overcome this undesirable affect of selecting a less desirable interface when a more desirable interface is available, the policy manager 104 adjusts the metric value of selected entries in the operating system's routing table 110 in accordance with the user's preferences and polices. The adjustment biases the metric value upward for less desirable interfaces, and downward when an interface becomes more desirable to use.

In some embodiments of the invention, the policy manager 104 may manipulate the routing table 110 directly. However, in alternative embodiments of the invention, the policy manager 104 must use an interface provided by the operating system in order to manipulate the routing table 110. An example of such an interface is the IP management interface 108. Typically the IP management interface 108 comprises a defined set of functions in an application program interface (API). The API typically includes functions that an application program may use to create, modify and delete route table entries. In some embodiments, the IP management interface 108 comprises the IP Helper interface from Microsoft Corporation. The IP Helper interface comprises a SDK (Software Developers Kit) and DLL (Dynamic Link Library) that provide interface functions to manipulate routing table entries maintained by the Microsoft Windows family of operating systems.

FIG. 2B provides an example of exemplary route table 200 after it has been adjusted in accordance with the user's preferences. The example assumes that the user has expressed a preference or policy that favors wired interfaces over wireless interfaces. The example further assumes that the nearest forwarding node for each interface is reachable in one hop, i.e. the metric value as assigned by the operating system is “1”. In the adjusted table, wireless entry 212 has been adjusted upward so that the metric value is now “2”. As a result, all else being equal, the operating system will select the wired interface entry 214 over the wireless interface entry 212 for transmitting packets.

This section has described the various software components in a system that provides for switching between available network interfaces based on user preferences. As those of skill in the art will appreciate, the software to implement the components can be written in any of a number of programming languages known in the art, including but not limited to C/C++, Java, Visual Basic, Smalltalk, Pascal, Ada and similar programming languages. The invention is not limited to any particular programming language for implementation.

### Methods of an Exemplary Embodiment of the Invention

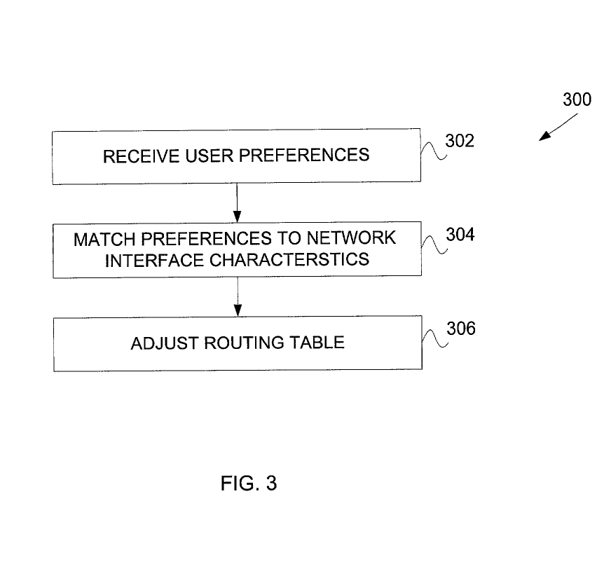

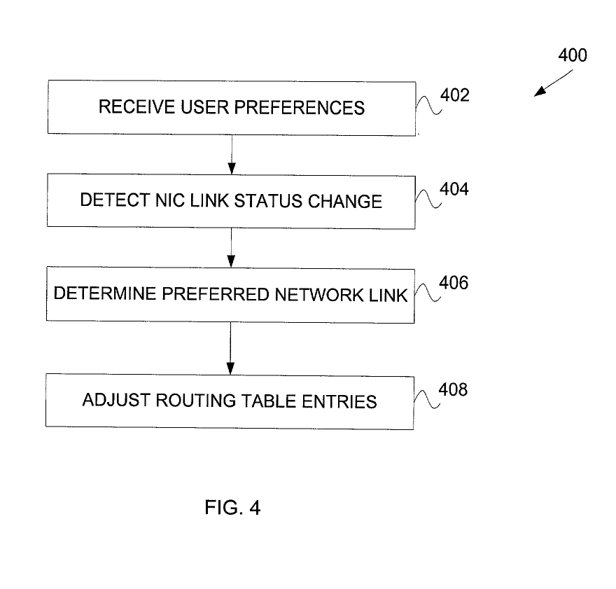

In the previous section, a system level overview of the operation of an exemplary embodiment of the invention was described. In this section, the particular methods of the invention performed by an operating environment executing an exemplary embodiment are described by reference to a series of flowcharts shown in FIGS. 3-4. The methods to be performed by the operating environment constitute computer programs made up of computer-executable instructions. Describing the methods by reference to a flowchart enables one skilled in the art to develop such programs including such instructions to carry out the methods on suitable computers (the processor of the computer executing the instructions from computer-readable media). The methods illustrated in FIGS. 3-4 are inclusive of the acts required to be taken by an operating environment executing an exemplary embodiment of the invention.

FIG. 3 is a flowchart illustrating a method for manipulating a routing table according to an embodiment of the invention. The method begins by receiving user preferences related to the use of network interfaces coupled to a computer (block 302). As noted above, in one embodiment the preferences are received as established by a user interface. However, the invention is not limited to the manner in which preferences are received. In alternative embodiments, the preferences may be received from registry entries, from environment variables, from a database or from configuration files.

Next, a system executing the method matches the preferences with network interface characteristics (block 304). As noted above, the preferences include preferences related to network interface type, cost and bandwidth. Further, the network interface characteristics include network bandwidth characteristics for the network interface and the network attached to the network interface, and network usage costs for the network. The process of matching compares the characteristics of the network interface with the preferences as expressed by the user. The network interface characteristics may be obtained in a variety of ways. In some embodiments, the link monitor 106 detects whether an interface is wired or wireless. In alternative embodiments, characteristics are read from the network interface device driver and reported up network stacks and operating system interfaces. Examples of such characteristics include bandwidth, signal strength and battery consumption. In further alternative embodiments, cost characteristics are obtained as part of the network connection handshaking process. The network interface whose characteristics most closely match the desired preferences is selected.

Next, the routing table is adjusted to cause the operating system to choose the network interface selected at block 304 when all other factors governing route selection are equal. In one embodiment of the invention, the metric value of less desirable network interface entries is raised. In alternative embodiments of the invention the metric value of the more desirable network interface is lowered. In further alternative embodiments, routing table entries for less desirable interfaces are removed from the routing table. In some embodiments of the invention, the metric values for network interfaces manufactured by vendors other than a selected vendor are left unadjusted, even if they may be less desirable. This capability is desirable because it prevents the other network interface card suppliers from asserting they are competitively disadvantaged by the interface switching of the present invention.

FIG. 4 is a flowchart illustrating an alternative method according to an embodiment of the invention for adjusting a routing table in accordance with user preferences when interface availability changes. The method begins by receiving user preferences (block 402). As in block 302 (FIG. 3), the preferences may be received from registry entries, from environment variables, from a database or from configuration files. The invention is not limited to any particular method of receiving preferences.

Next, the system executing the method detects a network interface link status change (block 404). The link status change can be due to a variety of factors. The following factors are provided as examples, however the invention is not limited to any particular reason for a link status change:

Insertion/removal of a network interface

Coupling/decoupling the network interface to/from a network access point

Network level link status changes (i.e. the network becomes inoperable)

Loss of carrier

Moving into or out from the range of a wireless transceiver

Upon detecting a link status change, the system executing the method then proceeds to determine the preferred network link (block 406). Like block 304, the determination is made by matching user preferences to network interface characteristics. The available network interface whose characteristics most closely match the user's preferences is selected. In some embodiments of the invention, the system executing the method obtains an IP address and adds a routing table entry when the link status change indicates a new network is available, and deletes an associated routing table entry and releases the associated IP address when the link status change indicates a network is no longer available.

Finally, the routing table entries are adjusted as necessary to cause the operating system to choose the network interface selected in the previous action (block 408). As noted above, the adjustment may be raising the metric of less desirable interfaces (i.e. those other than the selected network interface), lower the metric value of the preferred network interface, or remove route table entries for less desirable interfaces.

The above-described methods thus provide a mechanism for applying user preferences to routing decisions made by the operating system. The method as described in reference to FIG. 4 responds to changing link status conditions of available network interfaces.

### Conclusion

Systems and methods for interface switching based on user preferences are disclosed. The embodiments of the invention provide advantages over previous systems. For example, by allowing a user to tailor which network interface is used to transmit packets based on cost or bandwidth considerations, the systems and methods of the present invention are more flexible than previous systems that merely used a hop count to select an interface. Furthermore, the systems and methods can be applied to legacy operating systems without requiring changes to the operating system. Thus a user can receive the benefits of the present invention without having to upgrade to a new operating system. Additionally, the systems and methods of the invention can serve as a foundation for providing the ability of a network to “seamlessly” connect to new networks as the network becomes available.

Although specific embodiments have been illustrated and described herein, it will be appreciated by those of ordinary skill in the art that any arrangement which is calculated to achieve the same purpose may be substituted for the specific embodiments shown. This application is intended to cover any adaptations or variations of the present invention.

The terminology used in this application is meant to include all of these environments. It is to be understood that the above description is intended to be illustrative, and not restrictive. Many other embodiments will be apparent to those of skill in the art upon reviewing the above description. Therefore, it is manifestly intended that this invention be limited only by the following claims and equivalents thereof.

We claim:

1. A method for selecting a network interface, the method comprising:
receiving a policy specifying user preferences;
selecting a network interface from a plurality of network interfaces by matching the user preferences to a network interface characteristic; and
modifying a routing table entry associated with the selected network interface.

2. The method of claim 1, wherein the routing table entry includes a metric field and further wherein modifying the routing table entry includes modifying the metric field.

3. The method of claim 1, wherein modifying the routing table includes raising the priority of the routing table entry associated with the selected network interface.

4. The method of claim 1, wherein modifying the routing table includes lowering the priority of a routing table entry not associated with the selected network interface.

5. The method of claim 1, wherein modifying the routing table includes deleting a routing table entry not associated with the selected network device.

6. The method of claim 1, wherein receiving a policy includes receiving a policy specifying a network preference based on a cost of using a network communicably coupled to the network interface.

7. The method of claim 1, wherein receiving a policy includes receiving a policy specifying a network preference based on a battery consumption characteristic of the network interface.

8. The method of claim 1, wherein receiving a policy includes receiving a policy specifying a network preference based on the signal strength of the network interface.

9. The method of claim 1, wherein receiving a policy includes receiving a policy specifying a network preference based on a latency value associated with a network communicably coupled to the network interface.

10. The method of claim 1, wherein receiving a policy includes receiving a policy specifying a network preference based on a bandwidth associated with a network communicably coupled to the network interface.

11. The method of claim 1, wherein receiving a policy includes receiving a policy specifying a network preference based on a reliability value associated with a network communicably coupled to the preferred network interface.

12. The method of claim 1, wherein the policy is received from a user interface.

13. The method of claim 1, wherein the policy is received from a configuration file.

14. The method of claim 1, wherein the policy is received from an environment variable.

15. A computerized system comprising:
a user interface component operable to specify user preferences; and
a policy manager component operable to perform the tasks of:
receive the user preferences,
select a network interface from a plurality of network interfaces by matching the user preferences to a set of characteristics for a network interface, and
modify a routing table entry according to the selected network interface.

16. The computerized system of claim 15, further comprising a link monitor operable to notify the policy manager of changes in a link status of a network interface from the plurality of network interfaces.

17. The computerized system of claim 16, wherein the link monitor includes a wired link management component.

18. The computerized system of claim 16, wherein the link monitor includes a wireless link management component.

19. The computerized system of claim 16, wherein the link monitor notifies the policy manager of the link status change upon insertion or deletion of a network interface.

20. The computerized system of claim 16, wherein the link monitor notifies the policy manager of the link status change when a signal strength associated with the network interface crosses a predetermined threshold value.

21. The computerized system of claim 16, wherein the link monitor notifies the policy manager of the link status change upon a link roam.

22. The computerized system of claim 15, further comprising a routing table interface operable to provide a set of functions to modify the routing table.

23. A machine-readable medium having computer executable instructions to perform a method for selecting a network interface, the method comprising:
receiving a policy specifying user preferences;
selecting a network interface from a plurality of network interfaces by matching the user preferences to a network interface characteristic; and
modifying a routing table entry associated with the selected network interface.

24. The machine-readable medium of claim 23, wherein the routing table entry includes a metric field and further wherein modifying the routing table entry includes modifying the metric field.

25. The machine-readable medium of claim 23, wherein modifying the routing table includes raising the priority of the routing table entry associated with the selected network interface.

26. The machine-readable medium of claim 23, wherein modifying the routing table includes lowering the priority of a routing table entry not associated with the selected network interface.

27. The machine-readable medium of claim 23, wherein modifying the routing table includes deleting a routing table entry not associated with the selected network device.

28. The machine-readable medium of claim 23, wherein receiving a policy includes receiving a policy specifying a network preference based on a cost of using a network communicably coupled to the network interface.

29. The machine-readable medium of claim 23, wherein receiving a policy includes receiving a policy specifying a network preference based on a battery consumption characteristic of the network interface.

30. The machine-readable medium of claim 23, wherein receiving a policy includes receiving a policy specifying a network preference based on the signal strength of the network interface.

31. The machine-readable medium of claim 23, wherein receiving a policy includes receiving a policy specifying a network preference based on a latency value associated with a network communicably coupled to the network interface.

32. The machine-readable medium of claim 23, wherein receiving a policy includes receiving a policy specifying a network preference based on a bandwidth associated with a network communicably coupled to the network interface.

33. The machine-readable medium of claim 23, wherein receiving a policy includes receiving a policy specifying a network preference based on a reliability value associated with a network communicably coupled to the preferred network interface.
